(19) United States
(12) Patent Application Publication
(10) Pub. No.: US 2015/0248690 A1
(43) Pub. Date: Sep. 3, 2015

(54) Cost Optimization for Bundled Licenses

(71) Applicant: International Business Machines Corporation, Armonk, NY (US)

(72) Inventors: Li Ya Fan, Shangdi (CN); Nicholas C. Fuller, New York, NY (US); Jian B.J. Qiu, Beijing (CN); Zhe Zhang, New York, NY (US)

(73) Assignee: International Business Machines Corporation, Armonk, NY (US)

(21) Appl. No.: 14/195,154

(22) Filed: Mar. 3, 2014

(51) Int. Cl. G06Q 30/02; G06Q 30/06; G06Q 20/12

(52) U.S. Cl. CPC G06Q 30/0223; G06Q 20/1235; G06Q 30/0605

(57) ABSTRACT

Methods, systems, and articles of manufacture for cost optimization for bundled licenses are provided herein. A method includes generating a decision matrix associated with multiple licenses and multiple products, wherein said decision matrix comprises one or more programmable properties; populating the decision matrix with input, wherein said input comprises multiple product and license correlations among the multiple licenses and the multiple products associated with the decision matrix; applying one or more user-configurable rules to the populated decision matrix; and determining a cost optimization for the multiple licenses and the multiple products associated with the decision matrix based on said applying said one or more user-configurable rules to the populated decision matrix.

### FIELD OF THE INVENTION

Embodiments of the invention generally relate to information technology (IT), and, more particularly, to license optimization.

### BACKGROUND

Correlated software licenses and products can often present challenges in the form of upgrade and/or downgrade rights, as well as in connection with being bundled in one or more contracts. With respect to upgrade and/or downgrade rights, for example, each deployed license or product can be associated with a particular edition, and each relevant server can have a tier. In such a context, a required license may be determined by the combination of edition and tier, and an upgrade fee might apply in one or more circumstances.

With respect to correlated software licenses and products being bundled in contracts, for example, a number of software licenses can commonly be purchased in the same order pursuant to a given contract or set of contracts, and each such contract (or sub-contract) may offer a certain discount while other terms and conditions may apply to the entire contract.

Additionally, as is common, software licenses may not possess static properties.

For example, a price can change due to a discount condition, or license applicability can change due to an upgrade and/or downgrade. Accordingly, a need exists for software cost optimization techniques for bundled software licenses and correlated products.

SUMMARY

In one aspect of the present invention, techniques for cost optimization for bundled licenses are provided. An exemplary computer-implemented method can include steps of generating a decision matrix associated with multiple licenses and multiple products, wherein said decision matrix comprises one or more programmable properties; populating the decision matrix with input, wherein said input comprises multiple product and license correlations among the multiple licenses and the multiple products associated with the decision matrix; applying one or more user-configurable rules to the populated decision matrix; and determining a cost optimization for the multiple licenses and the multiple products associated with the decision matrix based on said applying said one or more user-configurable rules to the populated decision matrix.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and configured to perform noted method steps. Yet further, another aspect of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating an example embodiment, according to an aspect of the invention;

FIG. 2 is a flow diagram illustrating techniques according to an embodiment of the invention; and

FIG. 3 is a system diagram of an exemplary computer system on which at least one embodiment of the invention can be implemented.

### DETAILED DESCRIPTION

As described herein, an aspect of the present invention includes techniques for software cost optimization for bundled licenses and correlated products. As noted above, software products are commonly correlated, such as via different editions, etc. Additionally, many software vendors allow upgrade and/or downgrade rights in connection with such products. As also noted above, software licenses are commonly bundled into contracts, often offering discounted unit prices for each item in the contract.

Accordingly, and as further detailed herein, at least one embodiment of the invention includes modeling upgrade and/or downgrade and bundling contexts into mathematical forms, and solving queries related thereto automatically.

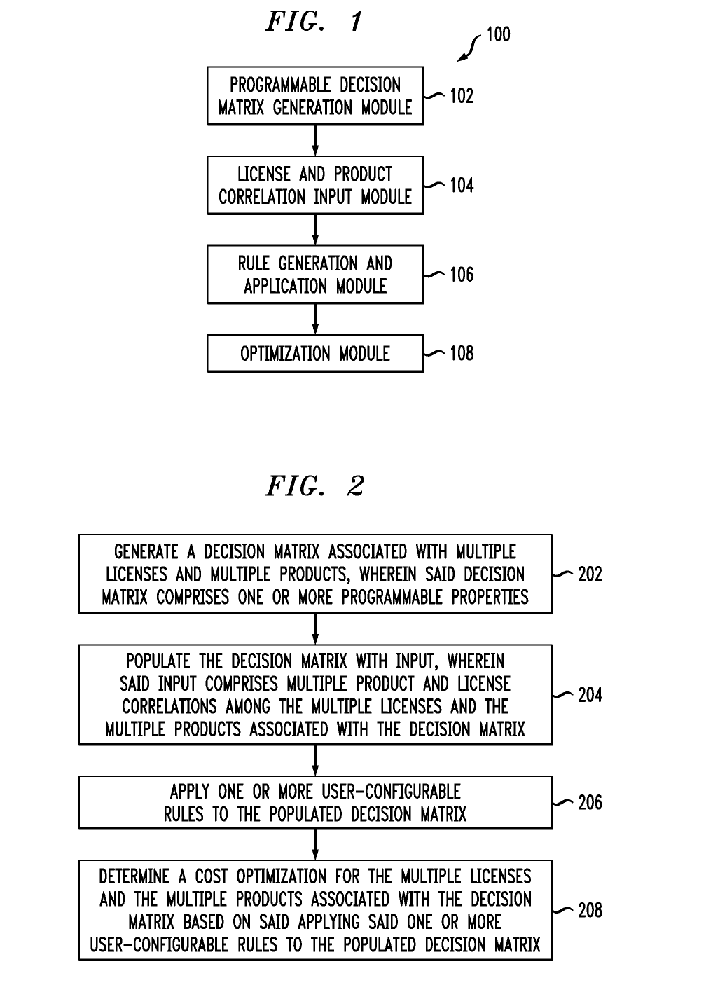

FIG. 1 is a block diagram illustrating an example embodiment, according to an aspect of the invention. By way of illustration, FIG. 1 depicts system 100 which includes a programmable decision matrix generation module 102, a license and product correlation input module 104, a rule generation and application module 106, as well as an optimization module 108. As illustrated in FIG. 1 and further detailed herein, programmable decision matrix generation module 102 generates a programmable decision matrix and/or table for software cost optimization, which allows a user to input product and license correlations in a unified format via license and product correlation input module 104. Additionally, such a programmable decision matrix and/or table facilitates development of configurable rules and/or policies via rule generation and application module 106 regarding which licenses can be upgraded or downgraded, and which contract or contracts can be discontinued. Further, as also detailed herein, application of such rules to the populated decision matrix enables a software cost optimization to be carried out via optimization module 108.

At least one embodiment of the invention includes providing two user-programmed rules to the decision matrix and/or table. Such rules, as described herein, can include a TRANSFORM rule and an IF-THEN rule. A TRANSFORM rule can include, for example, TRANSFORM(update₁, update₂, . . . ), whereby the decision matrix and/or table can be transformed with all realized updates. An IF-THEN rule can include, for example, IF(condition)-THEN(action), wherein if the condition is met, then the action is triggered.

Additionally, at least one embodiment of the invention includes providing rules as patterns, as well as implementing one or more heuristics and/or algorithms to solve one or more selected patterns, such as, for example, an algorithm utilized for handling license downgrades and/or upgrades.

Further, in at least one embodiment of the invention, the programmable decision matrix and/or table can be programmable on the basis of multiple properties. By way of examples, matrix properties that can be programmed can include license price, license quantity, applicability of a license to an IT asset, a required license or asset quantity, a preferred allocation of a license to an IT asset, and a parent-child relationship among IT assets and licenses. As used herein, assets differ from products. By way of example, Microsoft Office® is a software product. On the other hand, if a laptop is installed with Microsoft Office®, the ownership of Microsoft Office® is an asset.

Also, at least one embodiment of the invention includes implementation of various application programming interface (API) semantics, namely, different operators for different properties of a decision matrix. By way of example, every update, condition, and action allows flexible selection or programming of matrix properties. For instance, example semantics might include IF(ANY(SUM_COLUMN(license, allocation)<license, capacity)) THEN ( . . . ). Further, at least one embodiment of the invention includes using and/or permitting one or more wildcards within a selected group of a decision matrix. As used herein, THEN ( . . . ) refers to any action to the matrix. An example might include changing the price of one license.

As noted above, at least one embodiment of the invention includes utilization and application of user-programmed rules to the decision matrix and/or table, wherein such rules can include a TRANSFORM rule and an IF-THEN rule. As such, a TRANSFORM rule can, for example, increase a search space by 2^{N} times, where N is the number of possible transformations. As used herein, searching includes comparing all possible licensing plans and selecting the least expensive plan. Accordingly, “search space,” as used above, refers to the set of all possible plans.

Additionally, as also noted above, at least one embodiment of the invention includes providing rules as patterns, as well as implementing one or more heuristics to solve patterns. One exemplary pattern includes a license upgrade and/or downgrade pattern. With such a pattern, a TRANSFORM rule can result in updates to the following example properties:
The lower server tier and/or edition license quantity decrement;
The upper server tier and/or edition license quantity increment; and
Increases to the total cost by certain amount.

Accordingly, in at least one embodiment of the invention, a license decision matrix is stored as one or more tables in a computer's memory, and a TRANSFORM rule modifies values in the one or more tables.

Additionally, in such an example embodiment of the invention, heuristics for a single license metric case can include creating two sorted lists by price: one list for entitlements and one list for deployments. Two pointers can further be implemented, moving downward concurrently, until all deployments have been covered.

At least one embodiment of the invention can further include implementation of a user graphical user interface (GUI), whereby a user can disallow selected transformations. In accordance with such an embodiment, a user may want to keep a high-grade, expensive license from being degraded because the user wants to expand his or her environment and might need the license in the future.

Another exemplary pattern, as noted above, includes a license contracts pattern. With such a pattern, an IF-THEN rule can include, for example, a condition that a license's renewed quantity is smaller than an available quantity (also referred to herein as a contract being reduced). Also, with such a pattern, an action might include that all license prices increase to original values (whereby a discount may be voided).

Additionally, in such an example embodiment of the invention, a mathematical model for a single license metric case can include the following. Given m products and n contracts, and an input matrix: K=[kᵢⱼ]ₘₓₙ, wherein kᵢⱼ=the number of licenses purchased for the ith product and in the jth contract, the unit price for the ith product is pᵢ, and the price after any discount is pᵢⱼ′ (in the jth contract). Additionally, the total number of license requirements for the ith product is dᵢ, and aᵢⱼ=the number of licenses to purchase for the ith product and in the jth contract (for example, a decision variable).

The objective of such an example embodiment of the invention is to minimize the total cost as follows:

minΣᵢ₌₁^{m}Σⱼ₌₁ⁿαᵢⱼf(αᵢⱼ), such that Σⱼ₌₁ⁿαᵢⱼ≧dᵢ, and i=1, 2, . . . , m;
αᵢⱼ∈{0, 1, 2, . . . }; and
fᵢⱼ(α) is the unit price for the ith product in the jth contract:

$${f}_{ij} ( a ) = \{ \begin{matrix}{p}_{i} , ( {a}_{1 j} , {a}_{2 j} , … , {a}_{nj} ) & \neq & ( {k}_{1 j} , {k}_{2 j} , … , {k}_{nj} ) \\ {{p}^{′}}_{i} , ( {a}_{1 j} , {a}_{2 j} , … , {a}_{nj} ) & \neq & ( {k}_{1 j} , {k}_{2 j} , … , {k}_{nj} )\end{matrix} \} .$$

FIG. 2 is a flow diagram illustrating techniques according to an embodiment of the present invention. Step 202 includes generating a decision matrix associated with multiple licenses and multiple products, wherein said decision matrix comprises one or more programmable properties. Programmable properties can include, for example, license price, license quantity, applicability of a license to an asset, a preferred allocation of a license to an asset, and/or a parent-child relationship among one or more assets and one or more licenses. The techniques depicted in FIG. 2 can also include providing one or more application programming interfaces in connection with said one or more programmable properties of said decision matrix.

Step 204 includes populating the decision matrix with input, wherein said input comprises multiple product and license correlations among the multiple licenses and the multiple products associated with the decision matrix. In at least one embodiment of the invention, the input can be provided manually by a user and/or provided in a unified format.

Step 206 includes applying one or more user-configurable rules to the populated decision matrix. User-configurable rules can include one or more rules pertaining to upgrading and/or downgrading one or more licenses. Rules pertaining to upgrading and/or downgrading licenses can include a rule designating a transition from a first license to a second license in connection with a fee of a given amount. Additionally, rules pertaining to upgrading and/or downgrading licenses can include a rule designating that all license upgrading and downgrading results are to be displayed to identify each original license and each corresponding downgraded and/or upgraded license, as well as a rule designating one or more specific licenses disallowed from upgrading and/or downgrading.

Also, in at least one embodiment of the invention, user-configurable rules can include one or more rules pertaining to one or more contracts governing at least a portion of the multiple licenses and the multiple products associated with the decision matrix.

Rules pertaining to contracts can include, for example, a rule designating a given percentage discount applicable to all license prices within a given contract. Such a rule can also include removing applicability of said discount to a license, within the given contract, having a reduced quantity.

User-configurable rules can also include a TRANSFORM statement, wherein said TRANSFORM statement modifies the decision matrix with each of one or more realized updates. Further, user-configurable rules can include an IF-THEN statement, wherein said IF-THEN statement triggers a designated action in the decision matrix upon satisfaction of a given condition.

Step 208 includes determining a cost optimization for the multiple licenses and the multiple products associated with the decision matrix based on said applying said one or more user-configurable rules to the populated decision matrix.

The techniques depicted in FIG. 2 can also, as described herein, include providing a system (such as system 100 depicted in FIG. 1), wherein the system includes distinct software modules, each of the distinct software modules being embodied on a tangible computer-readable recordable storage medium. All of the modules (or any subset thereof) can be on the same medium, or each can be on a different medium, for example.

The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

An aspect of the invention or elements thereof can be implemented in the form of an apparatus including a memory and at least one processor that is coupled to the memory and configured to perform exemplary method steps.

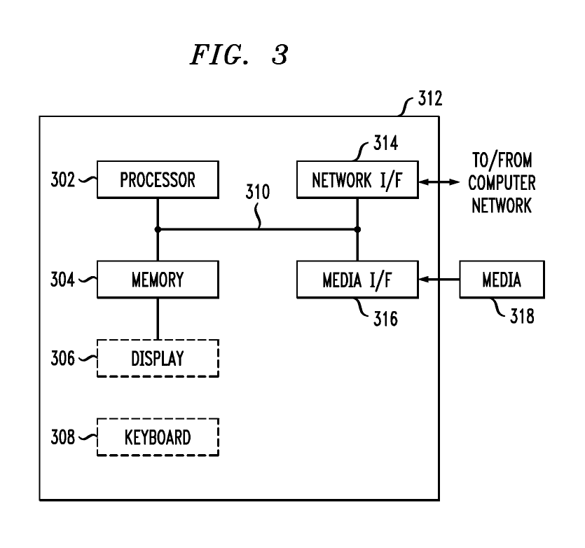

Additionally, an aspect of the present invention can make use of software running on a general purpose computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

As will be appreciated by one skilled in the art, aspects of the present invention may be embodied as a system, method and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, as noted herein, aspects of the present invention may take the form of a computer program product that may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored to therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, generating a programmable decision table for software cost optimization for bundled licenses and correlated products. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
generating a decision matrix associated with multiple licenses and multiple products, wherein said decision matrix comprises one or more programmable properties;
populating the decision matrix with input, wherein said input comprises multiple product and license correlations among the multiple licenses and the multiple products associated with the decision matrix;
applying one or more user-configurable rules to the populated decision matrix; and
determining a cost optimization for the multiple licenses and the multiple products associated with the decision matrix based on said applying said one or more user-configurable rules to the populated decision matrix;
wherein at least one of said generating, said populating, said applying and said determining is carried out by a computing device.

2. The method of claim 1, wherein said input comprises input provided in a unified format.

3. The method of claim 1, wherein said input comprises input provided manually by a user.

4. The method of claim 1, wherein said one or more programmable properties comprises license price.

5. The method of claim 1, wherein said one or more programmable properties comprises license quantity.

6. The method of claim 1, wherein said one or more programmable properties comprises applicability of a license to an asset.

7. The method of claim 1, wherein said one or more programmable properties comprises a preferred allocation of a license to an asset.

8. The method of claim 1, wherein said one or more programmable properties comprises a parent-child relationship among one or more assets and one or more licenses.

9. The method of claim 1, wherein said one or more user-configurable rules comprises one or more rules pertaining to upgrading and/or downgrading one or more licenses.

10. The method of claim 9, wherein said one or more rules pertaining to upgrading and/or downgrading one or more licenses comprises a rule designating a transition from a first license to a second license in connection with a fee of a given amount.

11. The method of claim 9, wherein said one or more rules pertaining to upgrading and/or downgrading one or more licenses comprises a rule designating that all license upgrading and downgrading results are to be displayed to identify each original license and each corresponding downgraded and/or upgraded license.

12. The method of claim 9, wherein said one or more rules pertaining to upgrading and/or downgrading one or more licenses comprises a rule designating one or more specific licenses disallowed from upgrading and/or downgrading.

13. The method of claim 1, wherein said one or more user-configurable rules comprises one or more rules pertaining to one or more contracts governing at least a portion of the multiple licenses and the multiple products associated with the decision matrix.

14. The method of claim 13, wherein said one or more rules pertaining to one or more contracts comprises a rule designating a given percentage discount applicable to all license prices within a given contract.

15. The method of claim 14, wherein said rule designating a given percentage discount applicable to all license prices within a given contract comprises removing applicability of said discount to a license, within the given contract, having a reduced quantity.

16. The method of claim 1, comprising:
providing one or more application programming interfaces in connection with said one or more programmable properties of said decision matrix.

17. The method of claim 1, wherein said one or more user-configurable rules comprises a TRANSFORM statement, wherein said TRANSFORM statement modifies the decision matrix with each of one or more realized updates.

18. The method of claim 1, wherein said one or more user-configurable rules comprises an IF-THEN statement, wherein said IF-THEN statement triggers a designated action in the decision matrix upon satisfaction of a given condition.

19. An article of manufacture comprising a computer readable storage medium having computer readable instructions tangibly embodied thereon which, when implemented, cause a computer to carry out a plurality of method steps comprising:
generating a decision matrix associated with multiple licenses and multiple products, wherein said decision matrix comprises one or more programmable properties;
populating the decision matrix with input, wherein said input comprises multiple product and license correlations among the multiple licenses and the multiple products associated with the decision matrix;
applying one or more user-configurable rules to the populated decision matrix; and
determining a cost optimization for the multiple licenses and the multiple products associated with the decision matrix based on said applying said one or more user-configurable rules to the populated decision matrix.

20. A system comprising:
a memory; and
at least one processor coupled to the memory and configured for:
generating a decision matrix associated with multiple licenses and multiple products, wherein said decision matrix comprises one or more programmable properties;
populating the decision matrix with input, wherein said input comprises multiple product and license correlations among the multiple licenses and the multiple products associated with the decision matrix;
applying one or more user-configurable rules to the populated decision matrix; and
determining a cost optimization for the multiple licenses and the multiple products associated with the decision matrix based on said applying said one or more user-configurable rules to the populated decision matrix.
